(19) United States
(12) Patent Application Publication
(10) Pub. No.: US 2025/0046542 A1
(43) Pub. Date: Feb. 6, 2025

(54) TRIGGER SWITCH

(71) Applicant: OMRON Corporation, KYOTO (JP)

(72) Inventors: Takumi FUJIHARA, Kyoto-shi (JP); Kazushi MAETA, Kyoto-shi (JP); Yohei TSUKANAKA, Kyoto-shi (JP); Takahiro UEDA, Kyoto-shi (JP); Kohei SUGIYAMA, Kyoto-shi (JP); Yusaku YAMASAKI, Kyoto-shi (JP)

(73) Assignee: OMRON Corporation, KYOTO (JP)

(21) Appl. No.: 18/735,219

(22) Filed: Jun. 6, 2024

(30) Foreign Application Priority Data
Jul. 31, 2023 (JP) 2023-124523

(51) Int. Cl. H01H 13/14; H01H 13/20

(52) U.S. Cl. CPC H01H 13/14; H01H 13/20

(57) ABSTRACT

A trigger switch which includes a trigger, a shaft member, and a housing includes a fixed engagement portion and a movable engagement portion which is operable that are engaged with each other to inhibit a movement of the trigger. The trigger includes a trigger cap and a holding member that holds the trigger cap and is supported by the shaft member. The trigger cap has a restricting portion and may be attached to and detached from the holding member. When the trigger cap is detached, the movable engagement portion moves to an engagement position, and inhibits the movement of the trigger by a pressing operation. When the trigger cap is attached, the movement of the movable engagement portion is restricted by the restricting portion, and the inhibition of the movement of the trigger is released.

### CROSS-REFERENCE TO RELATED APPLICATION

This application claims the priority benefits of Japanese application no. 2023-124523, filed on Jul. 31, 2023. The entirety of the above-mentioned patent application is hereby incorporated by reference herein and made a part of this specification.

### BACKGROUND

### Technical Field

The disclosure relates to a trigger switch which is provided with a trigger that receives a pressing operation.

### Description of Related Art

A trigger switch used to operate a power tool includes a trigger which receives a pressing operation by an operator and a shaft member which supports the trigger. When the operator places his/her finger on the trigger and pulls (pushes) the trigger, the shaft member moves in the operating direction, actuating the trigger switch and causing the power tool to operate. Such a power tool needs consideration of safety, such as preventing a malfunction. In addition, many power tools are expensive products, and taking safety into consideration from the perspective of preventing theft is needed. For example, Patent Literature 1 (Japanese Patent Application Laid-Open No. 2006-218575) discloses an electric power tool that performs authentication processing and remains in a usable state by sending and receiving information with an authentication device worn by a user, thereby increasing safety in terms of preventing theft.

Improving safety, such as preventing a malfunction and theft, is an important function of a power tool, and various technological developments are needed.

The disclosure provides a trigger switch which improves safety by preventing a malfunction, theft, etc.

### SUMMARY

A trigger switch which includes a trigger that receives a pressing operation by an operator and moves, a shaft member that supports the trigger at one end side, and a housing that is located on the other end side of the shaft member includes a fixed engagement portion and a movable engagement portion which is operable that are engaged with each other to inhibit a movement of the trigger due to the pressing operation. The trigger includes a trigger cap having a finger hook portion on which a finger of the operator is able to be hooked and a holding member that holds the trigger cap and is supported by the shaft member. The trigger cap has a restricting portion which restricts an operation of the movable engagement portion engaging with the fixed engagement portion, and is able to be attached to and detached from the holding member. When the trigger cap is detached, the movable engagement portion moves to an engagement position in which the movable engagement portion engages with the fixed engagement portion to inhibit a movement of the trigger due to the pressing operation. When the trigger cap is attached, the restricting portion restricts a movement of the movable engagement portion to a release position in which the movable engagement portion does not engage with the fixed engagement portion, thereby releasing inhibition of the movement of the trigger due to the pressing operation.

In addition, in the trigger switch, the fixed engagement portion is formed on the housing. The movable engagement portion is a part of a movable member attached to the holding member, and is configured to operate between the engagement position in which the movable engagement portion engages with the fixed engagement portion and the release position in which the movable engagement portion does not engage with the fixed engagement portion. The trigger cap, when attached to the holding member, moves the movable engagement portion from the engagement position to the release position by the restricting portion.

In addition, in the trigger switch, the movable member has the movable engagement portion which operates between the engagement position and the release position and abuts against and engages with the fixed engagement portion at the engagement position and a biasing portion which biases the movable engagement portion from a release position side to an engagement position side. The restricting portion of the trigger cap restricts the movable engagement portion so that the movable engagement portion does not move to the engagement position.

### BRIEF DESCRIPTION OF THE DRAWINGS

FIG. 1 is a schematic perspective view showing an example of the appearance of an electric device disclosed in the present application.

FIG. 2 is a schematic perspective view showing an example of the appearance of the trigger switch disclosed in the present application.

FIG. 3 is a schematic exploded view showing an example of the trigger switch disclosed in the present application.

FIG. 4 is a schematic cross-sectional view showing an example of the trigger cap included in the trigger switch disclosed in the present application.

FIG. 5 is a schematic cross-sectional view showing an example of the trigger switch disclosed in the present application.

FIG. 6 is a schematic cross-sectional view showing an example of the trigger switch disclosed in the present application.

### DESCRIPTION OF THE EMBODIMENTS

The trigger switch disclosed in the present application inhibits the movement of the trigger when the trigger cap is detached. Such a way brings about an exemplary effect such as being able to improve safety.

Hereinafter, embodiments of the disclosure are described with reference to the accompanying drawings.

### Application Example

A trigger switch disclosed in the present application is applicable to various electric devices including electric tools such as electric drills, electric drivers, electric wrenches, and electric grinders that are equipped with a drive portion such as a motor. Hereinafter, an electric device PT and a trigger switch 2 attached to the electric device PT will be described with reference to the drawings.

### <Electric Device PT>

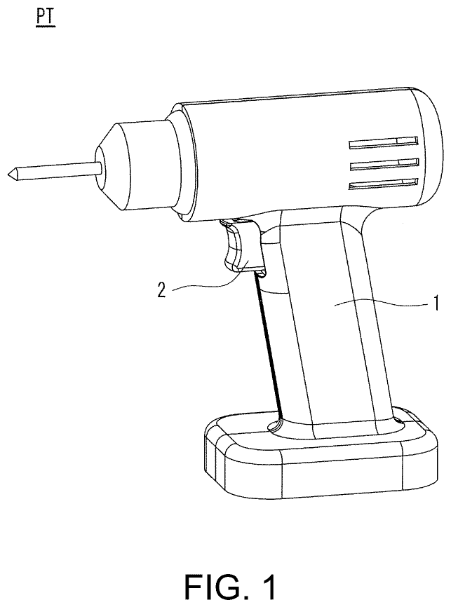

FIG. 1 is a schematic perspective view showing an example of the appearance of the electric device PT disclosed in the present application. The electric device PT disclosed in the present application may be applied to various devices such as electric tools such as electric drills, electric drivers, electric wrenches, and electric grinders, as well as water guns, paint guns, and model guns that are equipped with the trigger switch 2. The electric device PT illustrated in FIG. 1 includes a main unit 1, and the main unit 1 incorporates the trigger switch 2 that receives a pressing operation by a user. The electric device PT illustrated in FIG. 1 has a shape in which a hand-held portion is attached to the main body portion of a substantially cylindrical shape that accommodates a drive portion (not shown) such as an electric motor. In the following description, as shown in the drawings, the direction of the substantially cylindrical main body portion is referred to as the top, and the direction of the hand-held portion is referred to as the bottom. In addition, the direction in which a rotary tool portion such as a drill is attached is referred to as the front, and the direction in which the trigger switch 2 is pressed is referred to as the rear. That is, in the trigger switch 2 incorporated in the electric device PT, the direction from the front to the rear is the operating direction in which the trigger switch 2 is pushed in by a pressing operation. The directions are for the convenience of description and do not limit the directions in which the electric device PT and the trigger switch 2 can be used.

### <Trigger Switch 2>

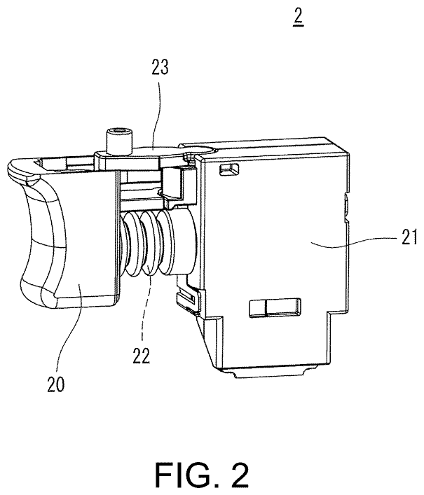

Next, the trigger switch 2 provided in the electric device PT will be described. FIG. 2 is a schematic perspective view showing an example of the appearance of the trigger switch 2 disclosed in the present application. The trigger switch 2 includes components such as a trigger 20, a housing 21, a shaft member 22, and a switching lever 23.

The trigger 20 is a member that receives a pressing operation by a user, and is incorporated in the electric device PT in an exposed state so as to be operable. The housing 21 contains various components such as various circuits and a spring that biases against the push of the trigger 20, and is incorporated inside the electric device PT. The shaft member 22 is a member that connects the trigger 20 and the housing 21. The shaft member 22 is an elongated metallic plunger, and is shown in FIG. 2 as being covered with a flexible bellows. The shaft member 22 supports the trigger 20 at a front end (one end side) thereof, and a rear end (the other end side) thereof is inserted into the housing 21. The switching lever 23 is a member for switching settings such as the operating direction and the operating mode.

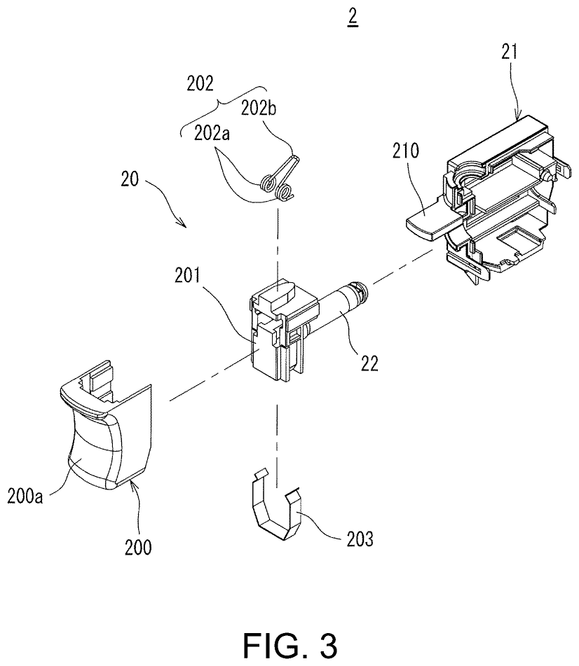

FIG. 3 is a schematic exploded view showing an example of the trigger switch 2 disclosed in the present application. In FIG. 3, the bellows, the switching lever 23, a part of the housing 21, and the internal structure of the housing 21 are omitted in order to make it easier to visually recognize the trigger 20 and surrounding members thereof included in the trigger switch 2 in the present application. The trigger 20 included in the trigger switch 2 includes various components such as a trigger cap 200, a holding member 201, a movable member 202, and a detachment prevention member 203.

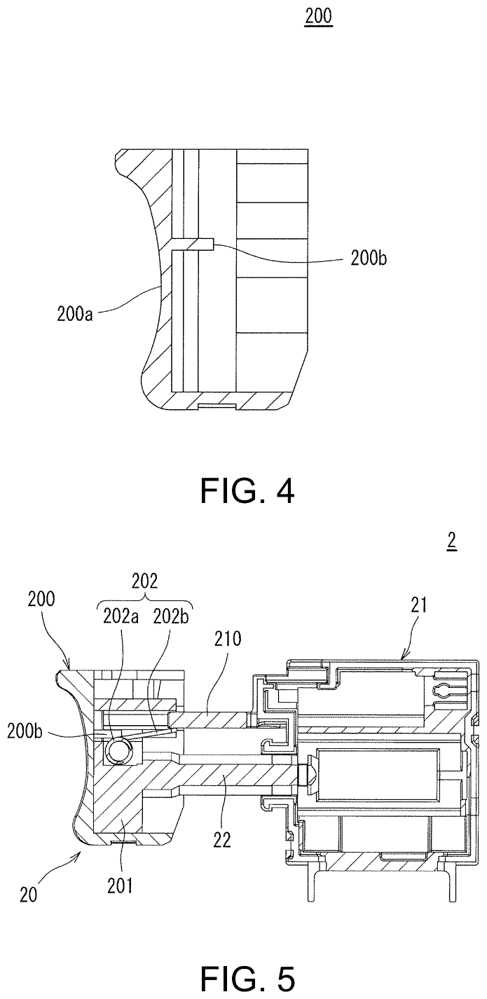

FIG. 4 is a schematic cross-sectional view showing an example of the trigger cap 200 included in the trigger switch 2 disclosed in the present application. FIG. 4 is a vertical cross-sectional view of the trigger cap 200 constituting the trigger 20 included in the trigger switch 2 as viewed from the left side. The trigger cap 200 will be described with reference to FIGS. 3 and 4. The trigger cap 200 may be attached to and detached from the holding member 201. The trigger cap 200 is formed in a generally rectangular box shape that is open at the top and rear. The trigger cap 200 has a finger hook portion 200a on the front surface on which the operator's finger can be hooked, and the finger hook portion 200a is curved in a concave shape to make it easy to hook the finger. A restricting portion 200b is formed on the inner wall surface at the front of the trigger cap 200 and protrudes rearward. The restricting portion 200b has a generally rectangular plate shape in a plan view, and is formed in a cantilevered state on the inner wall surface of the trigger cap 200 so that a longitudinal direction thereof coincides with the front-rear direction. The restricting portion 200b of the trigger cap 200 restricts the movement of a movable engagement portion 202b of the movable member 202 as described below.

Referring to FIG. 3 again, the holding member 201 is supported at the front end of the shaft member 22. The holding member 201 allows the trigger cap 200 to be attached and detached, and has the function of holding the attached trigger cap 200 when the trigger cap 200 is attached. The holding member 201 has projections and recesses formed on the front surface and the side surface, and when the trigger cap 200 is attached, the projections and recesses fit into projections and recesses formed on the inner wall surface of the trigger cap 200. Therefore, by appropriately designing the projections and recesses of the holding member 201 and the trigger cap 200, the trigger cap 200 may be configured to be attached merely to the specific holding member 201.

The movable member 202 is configured using members such as a torsion spring (torsion coil spring) and a leaf spring. The movable member 202 exemplified in the present application is a torsion spring in which a double coil is formed as a biasing portion 202a, and one arm extending long from the biasing portion 202a functions as the movable engagement portion 202b. The movable member 202 is movably attached to the holding member 201 by a guide rod (not shown) that is inserted into the biasing portion 202a. The movable member 202 has the movable engagement portion 202b extending rearward, and is biased by the biasing portion 202a so that the movable engagement portion 202b swings from a release position to an engagement position.

The movable engagement portion 202b of the movable member 202 is formed to be able to swing between the engagement position and the release position using the biasing portion 202a as a swing axis. The engagement position is a position in which the movable engagement portion 202b rises obliquely upward and rearward from the biasing portion 202a, and the release position is a position in which the movable engagement portion 202b is lowered from the biasing portion 202a so as to be substantially horizontal. When located in the engagement position, the movable engagement portion 202b engages with a fixed engagement portion 210 formed on the housing 21 side, and the engagement between the movable engagement portion 202b and the fixed engagement portion 210 inhibits the movement of the trigger 20 when pressed.

The detachment prevention member 203 is a substantially U-shaped clip that fixes the trigger cap 200 attached to the holding member 201 so as not to come off. The detachment prevention member 203 fits onto the side and bottom of the holding member 201 and supports the trigger cap 200 attached to the holding member 201 from the inside.

The housing 21 has a substantially rectangular box shape, and has an opening on the front surface through which the shaft member 22 is inserted, and an opening on the top surface through which the shaft of the switching lever 23 is inserted. Furthermore, the housing 21 has the fixed engagement portion 210 formed on the front surface thereof and protruding forward. The fixed engagement portion 210 has a generally rectangular plate shape in a plan view, and is formed in a cantilevered state on the front surface of the housing 21 so that the longitudinal direction thereof coincides with the front-rear direction. The fixed engagement portion 210 of the housing 21 and the movable engagement portion 202b of the movable member 202 are engaged with each other to inhibit the movement of the trigger 20 due to the pressing operation.

### <Attaching/Detaching the Trigger Cap 200>

Next, the states in which the trigger cap 200 is attached and detached will be described. FIG. 5 is a schematic cross-sectional view showing an example of the trigger switch 2 disclosed in the present application. FIG. 5 is a vertical cross-sectional view of the trigger switch 2 as viewed from the left side. In order to facilitate understanding of the internal structure, the switching lever 23 and the internal structure of the housing 21 are omitted. FIG. 5 shows a state in which the trigger cap 200 is attached to the holding member 201. When the trigger cap 200 shown in FIG. is attached, the restricting portion 200b of the trigger cap 200 is positioned so as to press the movable engagement portion 202b of the movable member 202 downward, and restricts the movement of the movable engagement portion 202b so that the movable engagement portion 202b is positioned at the release position in which the movable engagement portion 202b does not engage with the fixed engagement portion 210 of the housing 21. The movable engagement portion 202b of the movable member 202 is biased by the biasing portion 202a so as to rise up and move to the engagement position, but the restricting portion 200b restricts the movable engagement portion 202b from moving to the engagement position. Since the movable engagement portion 202b is located at the release position in which the movable engagement portion 202b does not engage with the fixed engagement portion 210, the movable engagement portion 202b does not engage with the fixed engagement portion 210 when the trigger 20 is pressed. That is, the inhibition of movement of the trigger 20 is released.

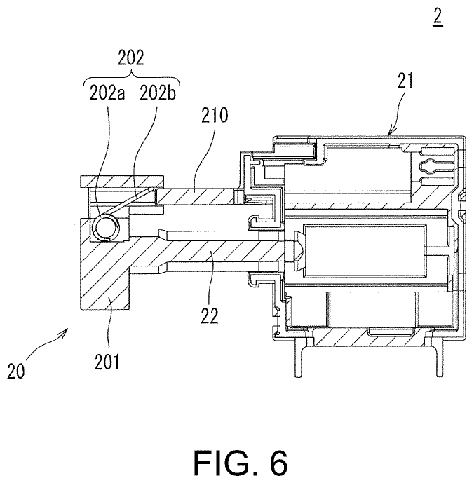

FIG. 6 is a schematic cross-sectional view showing an example of the trigger switch 2 disclosed in the present application. FIG. 6 is a vertical cross-sectional view of the trigger switch 2 as viewed from the left side. In order to facilitate understanding of the internal structure, the switching lever 23 and the internal structure of the housing 21 are omitted. FIG. 6 shows a state in which the trigger cap 200 is detached from the holding member 201. When the trigger cap 200 shown in FIG. 6 is detached, since the movable engagement portion 202b of the movable member 202 is not restricted in movement thereof by the restricting portion 200b, the movable engagement portion 202b of the movable member 202 is biased by the biasing portion 202a and positioned at a raised engagement position. Since the movable engagement portion 202b is located at the engagement position, even if the operator presses the trigger 20, the movable engagement portion 202b abuts against and engages with the fixed engagement portion 210, so that the movement of the trigger 20 is inhibited.

As described above, the trigger switch 2 disclosed in the present application includes the trigger cap 200 that can be attached to and detached from the holding member 201. When the trigger cap 200 is detached, the fixed engagement portion 210 and the movable engagement portion 202b are engaged with each other, thereby inhibiting the movement of the trigger 20 due to a pressing operation. In addition, when the trigger cap 200 is attached, the movable engagement portion 202b is restricted in movement to the release position in which the movable engagement portion 202b does not engage with the fixed engagement portion 210, thereby releasing the restriction on the movement of the trigger 20 and allowing the trigger 20 to be moved by the pressing operation.

Therefore, the trigger switch 2 disclosed in the present application has an exemplary effect of improving safety, such as preventing the occurrence of a malfunction in which, for example, the trigger 20 is unintentionally pressed and the electric device PT is operated, by detaching the trigger cap 200. In addition, with the trigger switch 2 disclosed in the present application, when the trigger cap 200 is detached, the electric device PT is unable to be operated unless the mating trigger cap 200 is attached, thereby providing an exemplary effect in terms of improving safety, such as preventing theft.

The disclosure is not limited to the embodiments described above, and may be implemented in various other forms. Therefore, the embodiments described above are merely illustrative in every respect, and should not be interpreted in a limiting manner. The technical scope of the disclosure is described by the claims and is not restricted by the text of the specification. Furthermore, all modifications and changes within the equivalent scope of claims are within the scope of the disclosure.

For example, in the above embodiment, a form is shown in which the movable member 202 having the movable engagement portion 202b is attached to the holding member 201, and the fixed engagement portion 210 is formed on the housing 21, but the trigger switch 2 disclosed in the present application is not limited thereto, and may be modified into various forms. For example, the trigger switch 2 disclosed in the present application may be deployed in various forms, such as by attaching the movable member 202 having the movable engagement portion 202b to the housing 21 and forming the fixed engagement portion 210 on the holding member 201.

That is, the trigger switch 2 disclosed in the present application may be deployed in various forms according to the following supplementary notes.

### (Note 1)

A trigger switch which includes a trigger that receives a pressing operation by an operator and moves, a shaft member that supports the trigger at one end side, and a housing that is located on the other end side of the shaft member includes
a fixed engagement portion and a movable engagement portion which is operable that are engaged with each other to inhibit a movement of the trigger due to the pressing operation.

The trigger includes
a trigger cap including a finger hook portion on which a finger of the operator is able to be hooked and
a holding member which holds the trigger cap and is supported by the shaft member.

The trigger cap includes
a restricting portion which restricts an operation of the movable engagement portion engaging with the fixed engagement portion, and
is able to be attached to and detached from the holding member.

When the trigger cap is detached, the movable engagement portion moves to an engagement position in which the movable engagement portion engages with the fixed engagement portion to inhibit the movement of the trigger due to the pressing operation.

When the trigger cap is attached, the restricting portion restricts a movement of the movable engagement portion to a release position in which the movable engagement portion does not engage with the fixed engagement portion, thereby releasing inhibition of the movement of the trigger due to the pressing operation.

### (Note 2)

In the trigger switch according to note 1,
the fixed engagement portion
is formed on the housing,
the movable engagement portion
is a part of a movable member attached to the holding member, and
is configured to operate between the engagement position in which the movable engagement portion engages with the fixed engagement portion and the release position in which the movable engagement portion does not engage with the fixed engagement portion, and
the trigger cap
moves the movable engagement portion from an engagement position to a release position by the restricting portion when attached to the holding member.

### (Note 3)

In the trigger switch according to note 2,
the movable member includes
the movable engagement portion which operates between the engagement position and the release position and abuts against and engages with the fixed engagement portion at the engagement position; and
a biasing portion which biases the movable engagement portion from a release position side to an engagement position side.

The restricting portion of the trigger cap restricts the movable engagement portion so that the movable engagement portion does not move to the engagement position.

What is claimed is:

1. A trigger switch which comprises a trigger that receives a pressing operation by an operator and moves, a shaft member that supports the trigger at one end side, and a housing that is located on the other end side of the shaft member, comprising:
a fixed engagement portion and a movable engagement portion which is operable, being engaged with each other to inhibit a movement of the trigger due to the pressing operation,
the trigger comprising
a trigger cap comprising a finger hook portion on which a finger of the operator is able to be hooked; and
a holding member which holds the trigger cap and is supported by the shaft member,
the trigger cap comprising
a restricting portion which restricts an operation of the movable engagement portion engaging with the fixed engagement portion, and
being able to be attached to and detached from the holding member,
when the trigger cap is detached, the movable engagement portion moving to an engagement position in which the movable engagement portion engages with the fixed engagement portion to inhibit the movement of the trigger due to the pressing operation, and
when the trigger cap is attached, the restricting portion restricting a movement of the movable engagement portion to a release position in which the movable engagement portion does not engage with the fixed engagement portion, thereby releasing inhibition of the movement of the trigger due to the pressing operation.

2. The trigger switch according to claim 1, wherein
the fixed engagement portion
is formed on the housing,
the movable engagement portion
is a part of a movable member attached to the holding member, and
is configured to operate between the engagement position in which the movable engagement portion engages with the fixed engagement portion and the release position in which the movable engagement portion does not engage with the fixed engagement portion, and
the trigger cap
moves the movable engagement portion from an engagement position to a release position by the restricting portion when attached to the holding member.

3. The trigger switch according to claim 2, wherein
the movable member comprises
the movable engagement portion which operates between the engagement position and the release position and abuts against and engages with the fixed engagement portion at the engagement position; and
a biasing portion which biases the movable engagement portion from a release position side to an engagement position side, and
the restricting portion of the trigger cap restricts the movable engagement portion so that the movable engagement portion does not move to the engagement position.
